(19) United States
(12) Patent Application Publication
(10) Pub. No.: US 2026/0120610 A1
(43) Pub. Date: Apr. 30, 2026

(54) DISPLAY AND DISPLAY CONTROL BOARD

(71) Applicant: REALTEK SEMICONDUCTOR CORP., Hsinchu (TW)

(72) Inventors: Yi-Hsuan Huang, Hsinchu (TW); Wan-Jou Lee, Hsinchu (TW); Ai Chung, Hsinchu (TW); Ya-Hui Chien, Hsinchu (TW); Chi-Jen Zhang, Hsinchu (TW); Tzuo-Bo Lin, Hsinchu (TW); Chun-Chieh Chan, Hsinchu (TW); Tsai-Chun Cheng, Hsinchu (TW); Fang-Hsiung Chen, Hsinchu (TW)

(73) Assignee: REALTEK SEMICONDUCTOR CORP., Hsinchu (TW)

(21) Appl. No.: 18/982,723

(22) Filed: Dec. 16, 2024

(30) Foreign Application Priority Data
Oct. 24, 2024 (TW) 113140647

(51) Int. Cl. G09G 3/20; G06V 10/82; G06V 20/40; G10L 25/57

(52) U.S. Cl. CPC G09G 3/2092; G06V 10/82; G06V 20/41; G10L 25/57; G06V 2201/02; G09G 2320/0613; G09G 2340/0407; G09G 2340/14

(57) ABSTRACT

A display includes a signal receiving port, a scaler, and an output interface. The signal receiving port is configured to receive media information. The scaler includes a detection module and a masking module. The detection module is configured to execute a recognition model, to determine whether the media information includes restricted information. The masking module is configured to mask the restricted information included in the media information, to generate filtered media information. The output interface is configured to play the filtered media information.

### CROSS-REFERENCE TO RELATED APPLICATION

This non-provisional application claims priority under 35 U.S. C. § 119(a) to Patent Application No. 113140647 filed in Taiwan, R.O. C. on Oct. 24, 2024, the entire contents of which are hereby incorporated by reference.

### BACKGROUND

### Technical Field

The present invention relates to a display and a control board thereof, and in particular, to a display configured to perform media information processing and a control board thereof.

### Related Art

Based on the development of current network technologies, dissemination of information has become very fast and unimpeded, but this raises a problem regarding sensitive information management. For example, a personal computer used at home and a network environment are not only used by a parent, but also may be accessible to young children. In addition, in an application scene of a personalized movie push-and-play function, a user cannot fully control content automatically played on a webpage. When a young child watches a video, if sensitive information such as a pornographic or violent video pops up unexpectedly, the sensitive information may have an adverse effect on mental development of the young child. In addition, out of curiosity, the young child may further click/tap an advertisement page of a phishing website, thereby increasing a risk of virus infection of the computer.

Although all restricted information is blocked through a server side, and this manner is feasible to some extent, a server itself may face a threat of a hacker attack, leading to a leakage of the sensitive information. In addition, for an adult user with autonomous determining ability, some information does not need to be subject to such strict control. Therefore, completely blocking all information also brings certain inconvenience.

### SUMMARY

In view of the above, the applicant provides a display, which includes a signal receiving port, a scaler, and an output interface. The signal receiving port is configured to receive media information. The scaler includes a detection module and a masking module. The detection module is configured to execute a recognition model, to determine whether the media information includes restricted information. The masking module is configured to mask the restricted information included in the media information, to generate filtered media information. The output interface is configured to play the filtered media information.

The applicant further provides a display control board, which is configured to process media information. The display control board include a detection module and a masking module. The detection module is configured to execute a recognition model, to determine whether the media information includes restricted information. The masking module is configured to mask the restricted information included in the media information, to generate filtered media information.

### BRIEF DESCRIPTION OF THE DRAWINGS

FIG. 1 is a block diagram of a media information playback system according to some embodiments;

FIG. 2 is a flowchart of information processing of a display according to some embodiments;

FIG. 3 is a block diagram of a detection module according to some embodiments;

FIG. 4 is a tree-like diagram of an information processing process of a detection module according to some embodiments;

FIG. 5A and FIG. 5B are schematic diagrams of generating filtered image information by a masking module according to some embodiments; and

FIG. 6A and FIG. 6B are flowcharts of generating filtered audio information by a masking module according to some embodiments.

### DETAILED DESCRIPTION

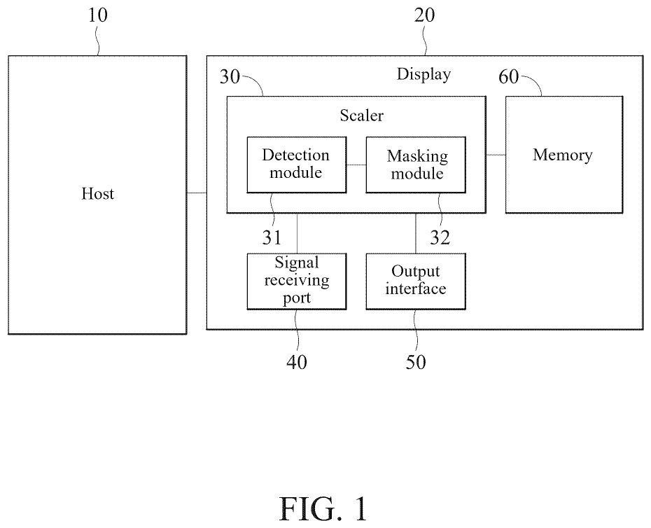

FIG. 1 is a block diagram of a media information playback system according to some embodiments, refer to FIG. 1. In this embodiment, the media information playback system includes a host 10 and a display 20. The display 20 is coupled to the host 10. The display 20 includes a scaler 30, a signal receiving port 40, an output interface 50, and a memory 60. The signal receiving port 40, the output interface 50, and the memory 60 are coupled to the scaler 30. The coupling allows one-way or two-way information transmission between elements, and is not limited to direct connection or indirect connection through another element. The host 10 is configured to generate media information. The media information is selected from a group composed of a sound, a picture, a video, a text, a symbol, and a combination thereof. The host 10 may be, but is not limited to, a personal computer, a mobile phone, tablet, a laptop computer, a server, or an embedded circuit.

The display 20 may be, but is not limited to, a liquid crystal display, a micro light emitting diode (LED) display, an organic light-emitting diode (OLED) display, or a plasma display. The scaler 30 is configured to process the media information. For example, the scaler 30 may adjust resolutions of image information of different signal specifications, to enable the image information to be adapted to a display specification of a display panel for clear display, or adjust the resolution of the image information, to enable the image information to be displayed in a blurred manner. Details are described later. The scaler 30 includes a detection module 31 and a masking module 32. The masking module 32 is coupled to the detection module 31. The detection module 31 and the masking module 32 may refer to functional chip units composed by the scaler 30 and program code executed by the scaler. Each code may be executed by a single chip or may be separately executed by a plurality of sub-chips. In some embodiments, the display 20 may further include a display control board, a timing controller (TCON), a display panel, and a backlight panel. In some embodiments, the display control board includes the scaler 30, and may further include an analog-to-digital converter coupled to the scaler 30, to convert media information in an analog format into a digital signal, and output the digital signal to the scaler 30 for processing. The timing controller is coupled to the display control board to control a timing signal of the media information (for example, image information including a plurality of frames), to adjust refresh rates of the display panel and the backlight panel. In some embodiments, the display 20 may further include an input interface, which is configured to adjust an operating state of the display 20. For example, a parent may enable or disable activation states of the detection module 31 and the masking module 32 through the input interface (for example a password window or another unlocking tool), to enable or disable a recognition function and a masking function of restricted information.

The signal receiving port 40 is configured to receive the media information. A communication interface of the signal receiving port 40 may include but is not limited to a USB-A, a USB-B, a USB-C, a Micro USB, a Mini USB, a USB 2.0, a USB 3.0, Lightning, an HDMI-A, an HDMI-B, an HDMI-C, an HDMI-D, a display port (DP), a digital visual interface (DVI), a video graphics array (VGA), a musical instrument digital interface (MIDI), an Ethernet interface, an audio port, a card slot, or a busbar. The output interface 50 may refer to a display panel, a backlight panel, or a speaker. The output interface 50 is configured to play media information processed by the display 20.

The memory 60 may be a flash memory or a read-only memory (ROM), for example, but not limited to, an erasable programmable ROM (EPROM), a flash ROM, an electrically EPROM (EEPROM), or a field-replaceable unit (FRU). The memory 60 may be configured to store program code, a model parameter, media information, or a state value executed by the scaler 30.

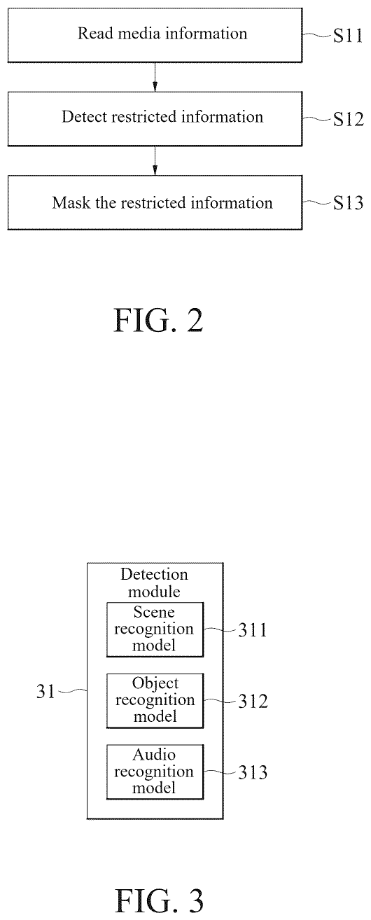

Referring to FIG. 1, in this embodiment, the display 20 receives the media information sent by the host 10, performs restricted information detection and masking processing on the media information, and then plays processed media information through the output interface 50. In this way, when a conventional display is connected to the host 10 in this embodiment, the display may play media information including the restricted information. When the display 20 in this embodiment is connected to the same host 10, the restricted information included in the media information played by the player is masked, thereby achieving an effect of blocking restricted information for a single user. FIG. 2 is a flowchart of information processing of a display according to some embodiments, refer to FIG. 2. In detail, a display 20 reads media information from a host 10 (step S11). A signal receiving port 40 receives the media information and then transmits the media information to a scaler 30. A detection module 31 of the scaler 30 executes a recognition model, to detect restricted information (step S12). When the recognition model determine that the restricted information exists in the media information, a masking module 32 of the scaler 30 masks the restricted information included in the media information (step S13), to generate filtered media information. An output interface 50 is configured to play the filtered media information. In some other embodiments, when the recognition model determines that no restricted information exists in the media information, next media information is continuously received. For example, the media information includes a plurality of frames of image information. When a frame of image is processed, the scaler 30 continuously processes a next frame of image. Alternatively, the media information includes an audio information stream. When an audio snippet is processed, the scaler 30 continuously processes a next audio snippet. Therefore, the display 20 masks the restricted information. The restricted information may refer to restricted information set by a manufacturer or a user, for example, media information with a property such as pornography, violence, suicide, a weapon, a drug, or gambling. The filtered media information may refer to media information in which the restricted information has been masked.

FIG. 3 is a block diagram of a detection module according to some embodiments, refer to FIG. 3. In this embodiment, a recognition model includes a scene recognition model 311, an object recognition model 312, and an audio recognition model 313. The scene recognition model 311 may be configured to perform a classification problem of recognizing whether an overall scene of image information includes restricted information. The overall scene may include one or more objects and a relative relationship between the objects. The object recognition model 312 may be configured to perform a classification problem of recognizing whether an individual object in the image information includes the restricted information, or perform a target detection problem of detecting a coordinate position of the restricted information within the overall scene (or the individual object) of the image information. The audio recognition model 313 may be configured to perform a classification problem of recognizing whether a stream or a snippet of audio information includes the restricted information, or perform a target detection problem of detecting a snippet timing of the restricted information within the stream of the audio information. In other embodiment, the recognition model may include only one or two of the scene recognition model 311, the object recognition model 312, and the audio recognition model 313. In addition, problems such as recognition of a scene, an object, and audio may also be performed by a single model or a plurality of independent models. For example, after determining that the overall scene of the image information includes restricted information, a single image recognition model reads a plurality of pictures in the scene one by one and determines whether the pictures include the restricted information.

The recognition model may be generated through training by using a dataset composed of a plurality of pieces of restricted information. For example, a manufacturer defines a type of the restricted information to collect the media information, and labels the restricted information to determine whether all or part of the media information belongs to the restricted information. A pornographic image is used as an example. The manufacturer may label an image including an exposed sexual organ, or label a pixel range including a sexual organ. Violent audio is used as another example. The manufacturer may label streaming audio including profanities, or label a streaming audio snippet including profanities. During data labeling, all or part of the media information may be labeled as “restricted” (a value of 1) or “unrestricted” (a value of 0) to construct the dataset. The dataset may be divided to construct a training dataset, a validation dataset, and a test dataset. In some embodiments, an allocation ratio of the training dataset, the validation dataset, and the test dataset is 8:1:1. The media information in the dataset may be normalized, so that a dimension of the image information or a length of the audio snippet is standardized. In some embodiments, feature extraction may be performed on the media information to extract feature information related to the restricted information, for example, a feature such as a profile, a boundary, a corner, or brightness of the restricted information.

An architecture of the recognition model may adopt a model such as a convolutional neural network (CNN) model or a region-based CNN (R-CNN) model to perform picture or audio classification or coordinate detection, or may select a model such as a recurrent neural network (RNN) model or a long short-term memory (LSTM) model to resolve a video or audio stream classification or recognition problem. The architecture of the recognition model may include an input layer, a hidden layer, and an output layer. The input layer may include a plurality of input ports and neurons, to receive a plurality of features. A neuron of the hidden layer is connected to each of the neurons of the input layer, and is connected to a neuron of the output layer or another hidden layer. An excitation function and hyperparameters (for example, a quantity of neurons of the hidden layer, an initial weight, an initial bias, and a learning rate) of the neuron are preset in a training phase, and model parameters such as a weight and a bias value of each neuron are generated based on minimization of a loss function in the training process. Each neuron receives a plurality of input values, multiplies the input values by the weight, adds the bias, then adds up the values, and outputs a sum of the values through the excitation function. In response to different models, the model parameters may include a weight set by each neuron function, for example, a weight of a hidden layer in the CNN model, or a weight of a function such as an input gate, an output gate, or a forget gate configured to update a state in the LSTM model. The output layer outputs a recognition result. The recognition result may be a probability of whether the media information includes the restricted information, or a probability in which the restricted information is located at a specific coordinate on the media information. The recognition result may also be an output of an existence state of the restricted information or a coordinate of the restricted information after threshold selection is performed on a probability value. The model parameters and the hyperparameters may be stored in the memory 60 after the model training is completed, and the detection module 31 may read the parameters from the memory 60.

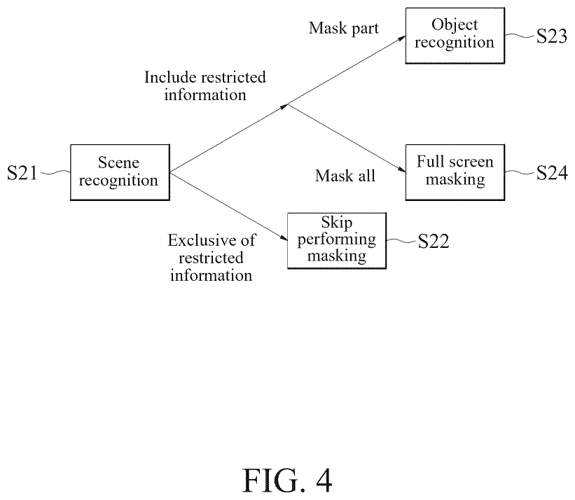

FIG. 4 is a tree-like diagram of an information processing process of a detection module according to some embodiments, refer to FIG. 4. In this embodiment, media information includes image information, and the image information includes a plurality of pieces of object information. A scene recognition model 311 performs scene recognition (step S21), to determine whether the image information includes restricted information. The scene recognition model 311 is configured to quickly recognize whether an overall scene includes the restricted information. For example, a pornographic webpage includes three nude pictures and five decorative pictures. The scene recognition model 311 performs restricted information classification on the entire pornographic webpage, without a need to classify pictures on the page one by one, to quickly determine a state of the overall scene. In this way, a scaler 30 may quickly determine a state of the image information frame by frame under limited operation resources. When the image information does not include the restricted information, the masking module 32 may not perform masking (step S22), to save operation resources and achieve real-time image processing. On the contrary, when the scene recognition model 311 determines that the image information includes the restricted information, a next step of processing is performed.

In some embodiments, when the scene recognition model 311 determines that the image information includes the restricted information, a masking module 32 performs full screen masking on the image information (step S24). In this way, the display 20 can achieve the masking of the restricted information with the limited operation resources. Similarly, in some other embodiments, the media information includes both the image information and the audio information. When the scene recognition model 311 determines that the image information includes the restricted information, a masking module 32 performs full screen masking on the image information (step S24), and simultaneously masks the audio information. In some embodiments, when the scene recognition model 311 determines that the image information includes the restricted information, an object recognition model 312 further performs object recognition (step S23), to determine whether each of the object information includes a state or a coordinate position of the restricted information. In some other embodiments, when the scene recognition model 311 determines that the image information includes the restricted information, an object recognition model 312 further performs object recognition (step S23), and an audio recognition model 313 further performs audio recognition, to determine whether each of the object information and the audio information each include the restricted information. In this way, the scaler 30 may accurately mask part of the restricted information, to balance usage experience of the display 20. In some other embodiments, the audio recognition model 313 performs audio recognition, to quickly recognize whether audio information includes the restricted information. When the audio information includes the restricted information, the object recognition model 312 further performs object recognition.

In some embodiments, the media information includes a plurality of frames of image information, and the scaler 30 receives the image information frame by frame and processes the image information in real time. However, an accuracy problem may arise when the recognition model is classifying the restricted information. To be specific, even if a same pornographic video continuously appears on the plurality of frames of image information, some frames of image information being determined as having no restricted information may still occur, which causes a flickering problem in filtered image information. In addition, the media information itself may also have a dynamic change. For example, a pornographic image is presented as a Flash animated picture, and alternately changes between a nude picture and a non-nude picture, which also results in the flickering problem in the filtered image information.

Therefore, in this embodiment, a detection module 31 simultaneously considers existence states of restricted information of a current frame of image information and a past frame of image information. In detail, the memory 60 stores first state information, and the detection module 31 reads the first state information from the memory 60. The first state information is used for storing the existence state of the restricted information of the past frame of image information determined by the detection module 31. For example, the first state information includes a sequence value [1,0,1,1,1,0,1,0,0,0], which indicates existence states of restricted information of past ten frames of image information. A value “1” at column 0 may indicate that an existence state of restricted information of a most recent frame of image information is determined as “existence”, and a frame of image information corresponding to each of columns 2, 3, 4, and 6 also has restricted information. In this embodiment, an input layer of the recognition model receives the image information (or an extracted feature thereof), and the input layer (or an input gate and a forget gate) simultaneously receives the first state information, to determine whether the current frame of image information includes the restricted information, and generate second state information (for example, “existence (1)” or “nonexistence (0)”). The detection module 31 stores the second state information in the memory 60 to update the first state information. For example, when it is determined that the current frame of image information has the restricted information, the first state information stored in the above memory 60 may be updated to a sequence value [1,1,0,1,1,1,0,1,0,0]. In this way, the recognition model determines the existence state of the restricted information of the current frame of image information based on determining results of the current frame of image information and past ten frames of image information, to suppress the flickering problem of the filtered image information. The first state information in this embodiment includes a sequence of a plurality of numerical values. In other embodiments, the first state information may be a single numerical value, for example, a state value of a past frame of image information, or a statistical value (for example, an average value) of a plurality of past frames of image information.

In some embodiments, each frame of image information includes a plurality of pieces of object information, and the first state information includes a plurality of pieces of first state sub-information, which respectively correspond to the plurality of pieces of object information. For example, the image information includes three pictures, and the first state information includes sequence values [1,1,0,1,1; 0,0,0,1,1; 1,1,1,0,0], which indicate existence states of restricted information of each of the object information of past five frames of image information. A sequence value “1,1,0,1,1” at row 0 may represent an existence state of restricted information of a first picture (that is, the first state sub-information), a sequence value “0,0,0,1,1” at row 1 may represent an existence state of restricted information of a second picture, and a numerical value “1” at column 0, row 0 may represent that an existence state of the restricted information of the first picture in the most recent frame of image information is determined as “existence”, and so on for other pictures. In this embodiment, an input layer of the object recognition model 312 receives each object information (or an extracted feature thereof), and the input layer (or an input gate and a forget gate) simultaneously receives the first state sub-information, to determine whether each picture of the current frame of image information includes the restricted information, and generate second state sub-information of each picture. For example, when it is determined that only a first picture of the current frame of image information has the restricted information, the first state information stored in the above memory 60 may be updated to sequence values [1,1,1,0,1; 0,0,0,0,1; 0,1,1,1,0]. In this way, the object recognition model 312 is able to suppress a problem of a flickering problem of some objects of the filtered image information.

In some other embodiments, the media information includes image information and audio information. Each frame of image information includes a plurality of pieces of object information. The first state information includes sequence values [1,1,0,1,1; 0,0,0,1,1; 1,1,1,0,0; 1,1,1,1,1]. Sequence values at rows 0-2 are existence states of restricted information of pictures, and a sequence value “1,1,1,1,1” at row 3 may represent an existence state of restricted information of the audio information. In this way, the input layer of the object recognition model 312 may receive the object information and the first state sub-information to perform object recognition, and the audio recognition model 313 may receive the audio information and the first state sub-information to perform audio recognition to suppress a sound interruption problem of the audio information.

Referring to FIG. 4, in some embodiments, the scene recognition model 311 receives only an input of the current frame of image information (or an extracted feature thereof), to quickly perform scene recognition (step S21). When it is determined that the overall scene includes the restricted information, the object recognition model 312 receives each object information (or an extracted feature thereof) of the current frame of image information and an input of the first state sub-information one by one, to accurately perform object recognition (step S23). In this way, the recognition model is capable of balancing processing efficiency of real-time image information and suppressing the flickering problem of the filtered image information. Similarly, in some other embodiments, the scene recognition model 311 receives only an input of the current frame of image information (or an extracted feature thereof), to perform scene recognition (step S21). When it is determined that the overall scene includes the restricted information, the object recognition model 312 receives each object information (or an extracted feature thereof) of the current frame of image information and an input of the first state sub-information one by one, and the audio recognition model 313 receives the audio information synchronized with the image information and the input of the first state sub-information, to perform restricted information recognition. In some embodiments, when determining that the overall scene includes the restricted information, the scene recognition model 311 generates third state information. The audio recognition model 313 receives the audio information synchronized with the image information and the input of the third state information, to perform recognition on the restricted information. In this way, considering that in a general network situation, when a pornographic picture appears on a webpage, there is a considerable probability that pornographic audio is carried secretly. A recognition result of the scene recognition model 311 helps improve determining accuracy of the audio recognition model 313.

In some embodiments, when the detection module 31 determines that a moving average of the state value sequence of the second state information is greater than an upper threshold limit, the masking module 32 masks the image information. The moving average may refer to an average calculated by using all numerical values of the first state information or a range of a plurality of recent numerical values as a window. For example, the first state information includes a sequence value [1,0,1,1,1,0,1,0,0,0], a pane has a size of 5, and a state value of a current frame is 1. The second state information includes a sequence value [1,1,0,1,1,1,0,1,0,0], and the moving average is (1+1+0+1+1)/5, that is, 0.8. Similarly, a moving average of a past frame is (1+0+1+1+1)/5, which is also 0.8. The threshold may refer to an absolute value set by a manufacturer or a user, for example, 0.5, or may refer to a relative numerical value calculated through statistics, for example, a multiple of a standard deviation of a numerical value in a moving window. In some other embodiments, when the detection module 31 determines that the moving average of the state value sequence of the second state information is less than a lower threshold limit, the masking module 32 plays the image information. Herein, the upper threshold limit and the lower threshold limit may be the same or different. Continuing with the above disclosed example, a sequence value of the moving average of each frame is [0.8,0.8,0.6,0.8,0.6,0.4,0.2]. Therefore, when the upper threshold limit and the lower threshold limit are 0.7, the masking state of the filtered image information is [1,1,0,1,0,0,0]. In some embodiments, when the moving average of the state value sequence is between the upper threshold limit and the lower threshold limit, the masking module 32 maintains a masking state or a playback state of the image information, to avoid the image flickering problem. Continuing with the above disclosed example, a sequence value of the moving average of each frame is [0.8,0.8,0.6,0.8,0.6,0.4,0.2]. Therefore, in a case that the upper threshold limit is 0.7 and the lower threshold limit is 0.5, the masking state of the filtered image information is [1,1,1,1,0,0,0].

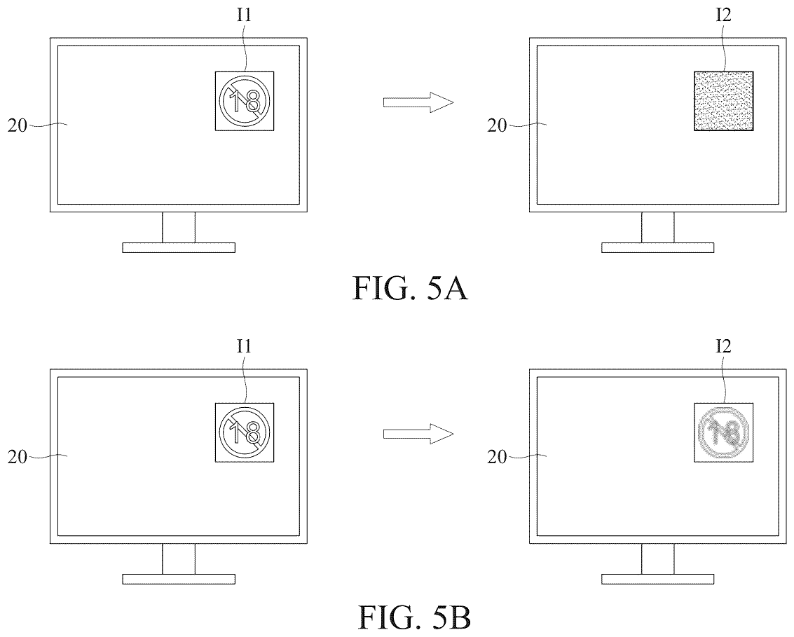

FIG. 5A and FIG. 5B are schematic diagrams of generating filtered image information by a masking module according to some embodiments, refer to FIG. 5A first. In this embodiment, a masking module 32 is configured to generate a mask I2, to mask restricted information included in object information I1. The mask I2 may refer to a picture, a video, a text, or a symbol, and covers the restricted information through on-screen display. As shown in FIG. 5B, in some other embodiments, a masking module 32 may adjust a resolution of object information I1 by using a function of the scaler 30, to enable the object information to be blurred, to mask restricted information. In some embodiments, when an image recognition model determines the existence of the restricted information and the masking module 32 masks image information, synchronized audio information may be also masked directly, to save processing resource consumption of an audio recognition model 313.

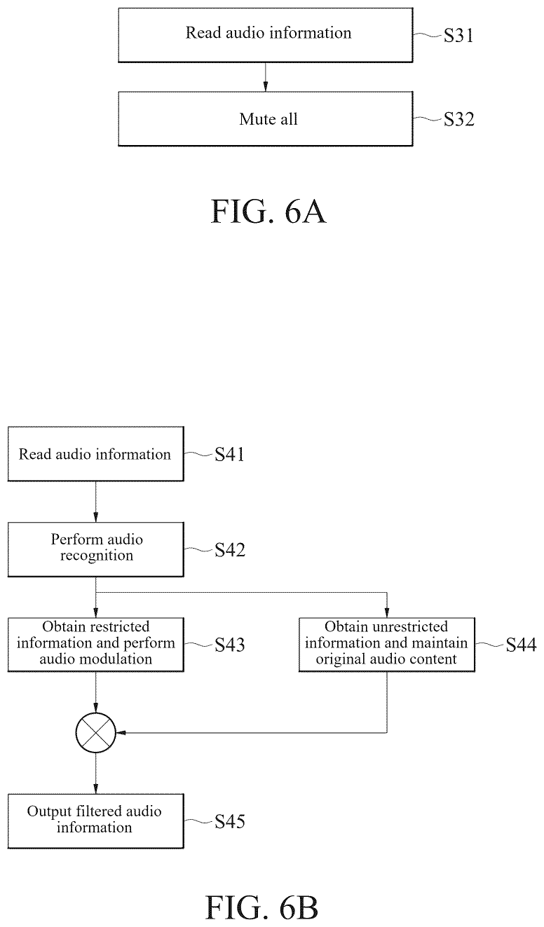

FIG. 6A and FIG. 6B are flowcharts of generating filtered audio information by a masking module according to some embodiments, refer to FIG. 6A first. In this embodiment, a masking module 32 reads audio information (step S31) and mutes all audio information by using a mask I2 (step S32), to mask restricted information included in the audio information. In this embodiment, the mask I2 may refer to a filter for a specific frequency or sound waveform feature, or may refer to an action of stopping playback of the audio information. As shown in FIG. 6B, in some other embodiments, a display 20 reads audio information (step S41) and performs audio recognition (step S42). An audio recognition model 313 may recognize an audio stream snippet including restricted information, or extract and separate an audio feature of restricted (or unrestricted information). In this embodiment, the audio recognition model 313 extracts the restricted information from the audio information and further extracts the unrestricted information from the audio information, to enable the two to be independent. The masking module 32 obtains the restricted information and performs audio modulation (step S43), to mask the restricted information included in the audio information. In addition, the masking module 32 obtains the unrestricted information and maintains original audio content (step S44), and mixes the modulated restricted information with the unrestricted information, to generate the filtered audio information. Finally, an output interface 50 of the display 20 outputs the filtered audio information (step S45). In other embodiments, after obtaining the restricted information, the masking module 32 may also filter or mute the restricted information by using the mask I2, and then mix the filtered or muted restricted information with the unrestricted information, to generate the filtered audio information. In some embodiments, when the audio recognition model 313 determines the existence of the restricted information and the masking module 32 masks the audio information, synchronized image information may also be masked directly, to save processing resource consumption of an image recognition model.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display, comprising:
a signal receiving port, configured to receive media information;
a scaler, comprising:
a detection module, configured to execute a recognition model, to determine whether the media information comprises restricted information; and
a masking module, configured to mask the restricted information comprised in the media information, to generate filtered media information; and
an output interface, configured to play the filtered media information.

2. The display according to claim 1, wherein the media information comprises image information, the image information comprises a plurality of pieces of object information, the recognition model comprises a scene recognition model and an object recognition model, and the detection module is configured to successively determine whether each of the object information comprises the restricted information based on the object recognition model after determining that the image information comprises the restricted information based on the scene recognition model.

3. The display according to claim 2, wherein the media information further comprises audio information, the recognition model further comprises an audio recognition model, and the detection module is configured to determine whether the audio information comprises the restricted information based on the audio recognition model after determining that the image information comprises the restricted information based on the scene recognition model.

4. The display according to claim 2, wherein the detection module is configured to continuously receive a next piece of image information after determining that the image information does not comprise the restricted information based on the scene recognition model.

5. The display according to claim 1, wherein the media information comprises image information and audio information, the image information comprises a plurality of pieces of object information, the recognition model comprises an object recognition model and an audio recognition model, and the detection module is configured to successively determine whether each of the object information comprises the restricted information based on the object recognition model after determining that the audio information comprises the restricted information based on the audio recognition model.

6. The display according to claim 1, further comprising a memory, wherein the media information comprises a plurality of frames of image information, and the detection module is further configured to:
read first state information stored in the memory;
read the plurality of frames of image information one by one;
determine, based on one of the plurality of frames of image information and the first state information, whether the one piece of image information comprises the restricted information, and generate second state information; and
store the second state information in the memory to update the first state information.

7. The display according to claim 6, wherein each of the plurality of frames of image information comprises a plurality of pieces of object information, the first state information comprises a plurality of pieces of first state sub-information respectively corresponding to the plurality of pieces of object information, the detection module is further configured to determine whether each of the object information comprises the restricted information based on each object information and each of the first state sub-information, and generate second state sub-information, and the second state information comprises a plurality of pieces of second state sub-information.

8. The display according to claim 6, wherein the media information further comprises audio information, and the detection module is further configured to:
read the plurality of frames of image information one by one and read the audio information synchronized with the image information; and
determine whether the one of the plurality of frames of image information and the synchronized audio information both comprises the restricted information based on the one piece of image information, the synchronized audio information, and the first state information, to generate the second state information.

9. The display according to claim 6, wherein the second state information comprises a state value sequence, and when the detection module determines that a moving average of the state value sequence is greater than an upper threshold limit, the masking module masks the image information.

10. The display according to claim 9, wherein when the detection module determines that the moving average of the state value sequence is less than a lower threshold limit, the masking module plays the image information; and when the detection module determines that the moving average of the state value sequence is between the upper threshold limit and the lower threshold limit, the masking module maintains a masking state or a playback state of the image information.

11. The display according to claim 1, wherein the media information comprises image information, the image information comprises a plurality of pieces of object information, and the masking module is configured to generate a mask, to mask the restricted information comprised in any of the object information.

12. The display according to claim 1, wherein the media information comprises image information, the image information comprises a plurality of pieces of object information, and the masking module is configured to adjust a resolution of any of the object information, to mask the restricted information comprised in the any object information.

13. The display according to claim 11, wherein the media information further comprises audio information, and when the recognition model determines that the image information comprises the restricted information, the masking module further masks the audio information.

14. The display according to claim 1, wherein the media information comprises audio information, and the masking module is configured to generate a mask to mask the restricted information comprised in the audio information.

15. The display according to claim 1, wherein the media information comprises audio information, and the masking module is configured to adjust a frequency of the audio information, to mask the restricted information comprised in the audio information.

16. The display according to claim 14, wherein the media information further comprises image information, and when the recognition model determines that the audio information comprises the restricted information, the masking module further masks the image information.

17. A display control board, configured to process media information, the display control board comprising:
a detection module, configured to execute a recognition model, to determine whether the media information comprises restricted information; and
a masking module, configured to mask the restricted information comprised in the media information, to generate filtered media information.

18. The display control board according to claim 17, further comprising a memory, wherein the media information comprises a plurality of frames of image information, and the detection module is further configured to:
Read first state information stored in the memory;
read the plurality of frames of image information one by one;
determine, based on one of the plurality of frames of image information and the first state information, whether the one piece of image information comprises the restricted information, and generate second state information; and
store the second state information in the memory to update the first state information.

19. The display control board according to claim 18, wherein each of the plurality of frames of image information comprises a plurality of pieces of object information, the first state information comprises a plurality of pieces of first state sub-information respectively corresponding to the plurality of pieces of object information, the detection module is further configured to determine whether each of the object information comprises the restricted information based on each object information and each of the first state sub-information, and generate second state sub-information, and the second state information comprises a plurality of pieces of second state sub-information.

20. The display control board according to claim 18, wherein the media information further comprises audio information, and the detection module is further configured to:
read the plurality of frames of image information one by one and read the audio information synchronized with the image information; and
determine whether the one of the plurality of frames of image information and the synchronized audio information both comprises the restricted information based on the one piece of image information, the synchronized audio information, and the first state information, to generate the second state information.
